(19) United States
(12) Patent Application Publication
(10) Pub. No.: US 2008/0050529 A1
(43) Pub. Date: Feb. 28, 2008

(54) Composition For Treating Glass To Improve Mechanical Strength Thereof Through Curing Of Surface Defects, Corresponding Treatment Methods And Resulting Treated Glasses

(75) Inventors: Sophie Besson, Paris (FR); Stephane Lohou, Paris (FR); Renaud Briard, Paris (FR); Caroline Heitz, Paris (FR); Etienne Barthel, Bourg La Reine (FR); Anne-Valentine Duffrene, Le Quesnoy (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Saint-Gobain Emballage, Courbevoie (FR)

(21) Appl. No.: 11/631,326

(22) PCT Filed: Jul. 1, 2005
(86) PCT No.: PCT/FR05/50529

§ 371 Date: Aug. 20, 2007

(30) Foreign Application Priority Data
Jul. 2, 2004 (FR) 0451430

(51) Int. Cl. B05D 3/10; C03C 8/14; C08F 2/48; C08F 30/08; C08F 8/30; C08G 77/00

(52) U.S. Cl. 427/387; 522/34; 522/99; 523/170; 525/123; 526/279; 528/10; 528/32

(57) ABSTRACT

This composition for treating the surface of glass, particularly flat glass or hollow glass, or else glass in the form of fibers, is able to be applied as a thin layer on said glass. It comprises, in aqueous medium, the following constituents (A) and (B): (A) at least one compound having at least one functional group f(A); and (B) at least one compound having at least one functional group f(_{B}) capable of reacting with the functional group or groups f_{(A)} of constituent (A) within the thin layer applied to the glass so as to convert said layer by polycondensation and/or polymerization into a solid layer, at least one of the compounds satisfying the definition of (A) and (B) having at least one R—O— functional group attached to a silicon atom, R representing an alkyl residue, and it being possible for at least some of the compounds having at least one R—O— functional group attached to a silicon atom to be in a hydrolyzed form resulting from prehydrolysis or spontaneous hydrolysis taking place during contact of the compound(s) with the aqueous medium.

The present invention relates to a composition for treating glass, particularly flat glass or hollow glass (bottles, flasks, etc.), or else glass in the form of fibers, in order to improve the mechanical strength of said glass by healing the surface defects thereof. It also relates to the corresponding treatment methods and to the glass thus treated.

International application WO 98/45216 discloses a method of manufacturing hollow glass containers, having a surface rendered impermeable, whereby an aqueous-based treatment agent is applied to the containers leaving the annealing lehr downstream of the machine for manufacturing the hollow glass containers, said treatment agent comprising:
(I) an aqueous-based composition containing organopolysiloxanes, which is prepared from an alkoxysilane carrying a functional group, such as an amino, alkylamino, dialkylamino, epoxy, etc., and from alkoxysilanes chosen from trialkoxysilanes, dialkoxysilanes and tetraalkoxysilanes; and
(II) a silicon-free component chosen from waxes, fatty acid partial esters and/or fatty acids, and possibly containing a surfactant.

The temperature of the surface of the glass during application of the treatment agent is raised to at least 30° C., being especially 30 to 150° C. The resistance to prolonged use of the containers is improved by this treatment.

International application WO 98/45217 discloses the application of this coating agent as a second layer, the first layer being obtained from a treatment agent containing a trialkoxysilane and/or a dialkoxysilane and/or a tetraalkoxysilane, or their hydrolysis and/or condensation products.

U.S. Pat. No. 6,403,175 B1 discloses an agent for the cold treatment of hollow glass containers for their surface reinforcement. This water-based agent contains at least the following components: a trialkoxysilane, a dialkoxysilane and/or a tetraalkoxysilane, their hydrolysis products and/or their condensation products; a water-soluble mixture of a polyol and of a polyol crosslinking agent, the layer of cold treatment agent thus applied then being crosslinked over a temperature range between 100 and 350° C.

The applicant company has however sought to further improve the mechanical strength of glass, in particular flat glass or hollow glass, or else glass in the form of fibers, and it has developed a novel coating composition that gives excellent results, said composition being an aqueous composition that can be polymerized or polycondensed on the surface of the glass in order to form a thin film that also reacts with the glass via SiOH or SiOR (R=alkyl) functional groups.

The subject of the present invention is therefore firstly a composition for treating the surface of glass, particularly flat glass or hollow glass, or else glass in the form of fibers, said composition being able to be applied as a thin layer on said glass, characterized in that it comprises, in aqueous medium, the following constituents (A) and (B):
(A) at least one compound having at least one functional group f_{(A);} and
(B) at least one compound having at least one functional group f(_{B}) capable of reacting with the functional group or groups f_{(A)} of constituent (A) within the thin layer applied to the glass so as to convert said layer by polycondensation and/or polymerization into a solid layer,
at least one of the compounds satisfying the definition of (A) and (B) having at least one R—O— functional group attached to a silicon atom, R representing an alkyl residue, and
it being possible for at least some of the compounds having at least one R—O— functional group attached to a silicon atom to be in a hydrolyzed form resulting from prehydrolysis or spontaneous hydrolysis taking place during contact of the compound(s) with the aqueous medium.

The alkyl residue R is especially a linear or branched, C₁-C₈ alkyl residue.

The functional groups f_{(A)} and f_{(B)} may in particular be chosen from —NH₂, —NH—, epoxy, vinyl, (meth)acrylate, isocyanate and alcohol functional groups.

In particular, the functional groups f_{(A)} and f_{(B)} of the respective constituents (A) and (B) may be chosen from the families given in the table below, together with the way in which the thin layer is formed by curing, either UV actuated or thermally actuated:

| | Way in which the thin |
|---|---|
| Family | layer is formed by curing |
| amine/epoxy | thermal |
| amine/(meth)acrylate | UV or thermal |
| epoxy/(meth)acrylate | UV or thermal |
| (meth)acrylate/(meth)acrylate | UV or thermal |
| vinyl/(meth)acrylate | UV or thermal |
| vinyl/vinyl | UV or thermal |
| epoxy/epoxy | UV or thermal |
| isocyanate/alcohol | thermal |

As regards the thermal curing, it should be pointed out that this includes curing at room temperature, which may be possible in certain cases.

As examples of compounds falling within the definition of constituents (A) and (B), mention may be made of:
melamine, ethylenediamine and 2-(2-aminoethylamino)ethanol (compounds not containing an SiOR or SiOH functional group);
derivatives of bisphenol A (compounds not containing an SiOR or SiOH functional group);
(meth)acrylate monomers or oligomers (compounds not containing an SiOR or SiOH functional group); and
compounds of formula (I):
   A-Si(R¹)ₓ(OR²)₃₋ₓ (I)
   in which:
A is a hydrocarbon radical possessing at least one group chosen from amino, alkylamino, dialkylamino, epoxy, acryloxy, methacryloxy, vinyl, aryl, cyano, isocyanato, ureido, thiocyanato, mercapto, sulfane, or halogen group linked directly to the silicon or via an aliphatic or aromatic hydrocarbon residue;
R¹ represents an alkyl group, in particular a C₁-C₃ alkyl group, or A as defined above;
R² represents a C₁-C₈ alkyl group, possibly substituted with an alkyl[polyethylene glycol] residue; and
x=0 or 1 or 2.

Mention may be made in particular of the following (A)/(B) combinations:
methacryloxypropyltrimethoxysilane/polyethylene glycol diacrylate;
methacryloxypropyltrimethoxysilane/glycidoxypropylmethyldiethoxysilane; and
3-aminopropyltriethoxysilane/glycidoxypropylmethyldiethoxysilane.

According to one particular embodiment, the functional groups f_{(A)} of constituent (A) are —NH₂ and/or —NH— functional groups and the functional groups f_{(B)} of constituent (B) are epoxy functional groups, the ratio of the number of —NH— functional groups of constituent (A) to the number of epoxy functional groups is between 0.3/1 and 3/1, limits inclusive, especially between 0.5/1 and 1.5/1, limits inclusive.

One particular composition according to the invention may be mentioned, which comprises 3-aminopropyltriethoxysilane as constituent (A) and glycidoxypropylmethyldiethoxysilane as constituent (B), the latter being advantageously introduced in the prehydrolyzed state.

Once they have been introduced into the aqueous medium, constituents (A) and (B), at least one of which includes at least one —SiOR functional group, undergo a hydrolysis of the —SiOR functional group(s) into —SiOH over a relatively long period of time after the contacting with water. In some cases, it is necessary to add an acid, such as hydrochloric acid or acetic acid, in order to catalyze the hydrolysis.

The condensation of the —SiOH functional groups into —SiO—Si— groups may even start at room temperature. Thus there may be (A)+(A) reactions, (A)+(B) reactions and (B)+(B) reactions via the —SiOH functional groups, it being possible for these reactions under certain conditions to participate in the formation of a three-dimensional siloxane network. However, it will be advantageous to choose constituents (A) and (B) and the operating conditions so that this network forms only very partially in aqueous solution.

According to the present invention, the composition is intended to be applied to the glass to be treated and to form a thin layer by polymerization or polycondensation, by the functional groups f_{(A)} of constituent (A) reacting with the functional groups f_{(B)} of constituent (B).

Moreover, the product of the polycondensation reacts with the glass via the SiOH and SiOR radicals, thus making it possible to heal the surface defects on the glass, namely checks, cracks, impacts, etc. The film thus formed is intended to improve the mechanical strength of the glass.

The composition according to the invention may further comprise:
(C1) at least one catalyst for polymerizing or polycondensing constituents (A) and (B); and/or

(C2) at least one UV or thermal, or UV cationic, radical curing initiator,

depending on the method of forming the hard coating used.

Advantageously, constituent (C1) is or comprises a tertiary amine, such as triethanolamine and diethanolamine propanediol. In general, examples of tertiary amines which may be mentioned include those of formula (III): 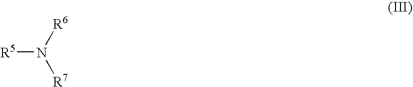
in which R⁵ to R⁷ each represent, independently, an alkyl group or hydroxyalkyl group. The presence of at least one catalyst makes it possible to reduce the curing time and the curing temperature, avoiding, when coating flasks or similar products, having to use an additional curing lehr and making it possible to work at the temperature of the bottles leaving the annealing lehr (for example at 150° C.), as will be explained below.

The radical curing initiators (C2) are for example mixtures comprising benzophenone, such as IRGACURE®500 sold by Ciba Specialty Chemicals.

The composition of the invention may further comprise:
(D) at least one agent for protecting against scratching and rubbing, chosen from waxes, partial fatty acid esters and the fatty acids, and polyurethanes and other polymers known for their protective function, such as acrylic polymers; and/or
(E) at least one emulsion polymer, the T_{g} of which is between 0 and 100° C., particularly between 10 and 80° C.; and/or
(F) at least one surfactant, such as an anionic or nonionic surfactant.

As examples of waxes, mention may be made of polyethylene waxes, whether oxidized or not.

The waxes, fatty acid partial esters and fatty acids may be introduced into the composition in the state combined with a surfactant.

The protective agents (D) are thermoplastics and possess elastic slip properties. Their inclusion into the thin film formed helps to protect the glass from scratches and rubbing in use and when being handled.

The emulsion polymers (E) are in particular chosen from acrylic copolymers in emulsion, such as those of the HYCAR® series sold by Noveon.

As examples of surfactants (F), mention may be made of fatty ethers of polyoxyethylene, such as C₁₈H₃₅(OCH₂CH₂)₁₀OH, known by the name BRIJ®97, and also polyethylene oxide/polypropylene oxide/polyethylene oxide triblock copolymers. Mention may also be made of the surfactants used in the examples below.

The composition according to the invention may thus comprise, in aqueous medium, for a total of 100 parts by weight:
up to 25 parts by weight of constituent (A);
up to 25 parts by weight of constituent (B);
0 to 25 parts by weight of constituent (C1) as defined above;
0 to 25 parts by weight of constituent (C2) as defined above;
0 to 25 parts by weight of constituent (D) as defined above;
0 to 25 parts by weight of constituent (E) as defined above; and
0 to 25 parts by weight of constituent (F) as defined above,
   the aforementioned quantities being indicated as dry matter and, when an agent is introduced in the form of an aqueous solution or emulsion, the quantity of water of this solution or emulsion then forming part of the aqueous medium of the composition.

The composition according to the invention advantageously has a viscosity at room temperature between 1 and 3 centipoise according to the rotary cylinder method (RHEOVISCO LV Brookfield viscometer: speed=60 rpm; low-viscosity accessory).

The subject of the present invention is also a method of treating the glass surface in order to improve its mechanical strength by healing the surface defects, characterized in that a thin film of the composition as defined hereabove is applied, to the glass parts to be treated, with a thickness that may range up to 3 microns, and said composition undergoes a polymerization or polycondensation reaction.

The composition according to the invention may be prepared, for the purpose of applying it, by mixing its constituents, generally at the moment of use, in various ways:

When the composition according to the invention contains constituents (A)+(B)+water, it may be prepared by firstly mixing (A)+(B) and then combining this mixture with water at the moment of use.

It is also possible to prehydrolyze (A) and/or (B).

If catalysts and/or additives are present, they may be mixed with water, before mixing with (A)+(B) at the moment of use.

It is also possible, in the case in which one of the constituents, (A) or (B), is hydrolyzed, to incorporate the additives into the non-hydrolyzed constituent.

Advantageously, the composition is applied by spray coating or dip coating.

To form the thin hard layer, the applied film may be dried, for example for a few seconds, and then passed beneath UV lamps, the UV treatment lasting, for example, from a few seconds to 30 seconds.

The thermal polymerization or polycondensation may be carried out at a temperature of for example 100 to 200° C., for 5 to 20 minutes. However, the treatment temperature and treatment time depend on the system used. Thus, it is possible to use systems that allow thermal formation of the hard thin layer at room temperature almost instantly.

If the glass to be coated is hollow glass, the method consists in depositing the composition by spraying it onto the hollow glass after the annealing lehr, the temperature of the hollow glass during the spraying being from 10-150° C., and
when the composition does not contain a catalyst, then making the hollow glass pass through a curing lehr at a temperature between 100 and 220° C. for a period of time ranging from a few seconds to 10 minutes; and
when the composition does contain a catalyst, in allowing the curing to take place without passing through a curing lehr.

The present invention also relates to flat glass or hollow glass treated by a composition as defined above, using the method as defined above, and also to glass fibers, especially optical fibers (for example those useful for dentists' lamps), treated by a composition as defined above, using the method as defined above.

The present invention also relates to the use of a composition as defined above, for improving the mechanical strength of the glass by healing the surface defects of the glass.

The following examples illustrate the present invention without however limiting its scope. In these examples, unless otherwise indicated, the parts and percentages are by weight.

In these examples:
SR610 is a 600 polyethylene glycol diacrylate sold by Cray Valley;
the CRAY VALLEY blend is a blend consisting of 67% SR610, as defined above, and 33% of an aliphatic diacrylate oligomer sold under the name CN132 by Cray Valley. Since the CN132 is barely miscible in water, it is necessary to predissolve it in the SR610;
the GK6006 wax is a polyethylene wax having a 25% solids content, sold by Morells;
the OG25 wax is a polyethylene wax having a 25% solids content, sold by Trub Emulsion Chemie AG; and
IRGACURE® 500 is the brand name of a radical curing initiator sold by Ciba, consisting of 50% benzophenone and 50% 1-hydroxycyclohexyl phenyl ketone.

### EXAMPLE 1a

### Flat Glass Provided With a Coating Layer Formed By Drying Followed By UV Crosslinking

(a) Preparation of the Coating Composition

The following formulation was used, the quantities being given in parts by weight:

| | |
|---|---|
| Methacryloxypropyltrimethoxysilane | 1.5 |
| 600 Polyethylene glycol diacrylate SR610 | 0.5 |
| GK6006 wax | 1.5 |
| Surfactant of the family of modified | 0.1 |
| polysiloxanes, sold by Byk under the name | |
| BYK 341 | |
| IRGACURE 500 | 0.15 |
| Water | balance to |
| | 100 |

A glass coating composition was prepared by hydrolyzing the silane of the formulation in water for 24 hours, then adding the other constituents of the formulation.

(b) Formation of the Coating Layer on Flat Indented Glass Plates

The composition thus obtained was deposited on a batch of 10 flat glass plates (measuring 70×70×3.8 mm) on which defects had been created by Vickers indentation with pyramidal diamond tip and an applied force of 50 N.

The coating was applied by dip coating at a controlled rate of 500 mm/min to ensure uniform thickness. This coating was applied 24 hours after the indentation so that crack propagation was stabilized and stresses around the defect created were relaxed.

The glass plates were then dried for 10 minutes at 100° C., then the layer applied as a coating underwent UV curing for 25 seconds, the characteristics of the UV emitter being the following:
distance from the surface of the substrate to the lamp: 5 cm;
iron-doped mercury lamp (type-F Strahler UVH lamp); and
power: 150 W/cm.

(c) Fracture Test in Three-Point Bending

The glass plates thus coated were subjected to the three-point bending fracture test, putting the defect created into extension. This test was carried out without UV and environmental ageing of the coatings formed.

One batch of 10 flat glass plates was not coated and used as controls.

The results of the three-point fracture are expressed as the modulus of rupture (MOR) (in MPa) and serve for evaluating the reinforcing performance of the composition. The reinforcement results for the coating represent the difference in the modulus of rupture values in the bending test between the controlled flat glass plates and the treated flat glass plates.

The results are given in Table 1 below.

TABLE 1

| | | Glass treated by |
|---|---|---|
| | | the formulation |
| | Uncoated controls | of this example |
| Mean fracture | 38.9 | 80.9 |
| stress (MPa) | | |
| Standard | 2.9 | 20 |
| deviation (MPa) | | |
| Reinforcement | | 107.8% |

The formulation of this example shows a very pronounced reinforcing effect for the embrittled glass plates, this reinforcement being in fact 107.8% compared to indented flat glass plates without a coating.

The graph shown in FIG. 1 expresses the cumulative percent fracture as a function of the modulus of rupture in MPa. The curve representing the 10 specimens of coated flat glass plates is shifted toward the highest modulus of rupture values compared with the curve for the ten specimens of uncoated flat glass plates.

The coating formed from the composition of this example therefore gives the glass better mechanical strength.

### EXAMPLES 1b and 1c

### Flat Glass Plates Provided With a Coating Layer Formed By Drying Followed By UV Crosslinking

The following formulations were used, the quantities being given in parts by weight:

### EXAMPLE 1b

| | |
|---|---|
| Aminopropyltriethoxysilane | 1 |
| CRAY VALLEY blend | 10 |
| Sodium dodecylsulfate (surfactant) | 0.3 |
| IRGACURE 500 | 0.25 |
| Water | balance to |
| | 100 |

### EXAMPLE 1c

| | |
|---|---|
| Methacryloxypropyltrimethoxysilane | 1 |
| CRAY VALLEY blend | 10 |
| Acrylated surfactant sold by Byk under the | 1 |
| name BYK 3500 UV | |
| Copolymer surfactant sold under the name | 0.2 |
| GANTREZ | |
| Sodium dodecylsulfate (surfactant) | 0.5 |
| Water | balance to |
| | 100 |

For each of the formulations of Examples 1b and 1c, the procedure was as in Example 1a except that the crosslinking times were around 20 seconds.

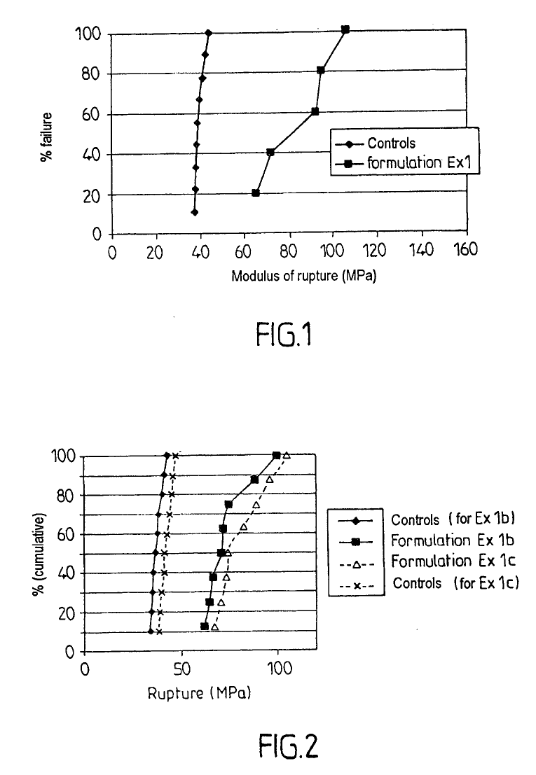

The results are expressed by the graph shown in FIG. 2 of the appended drawing. Each treatment should be compared with its respective control. The two formulations appeared to give reinforcements of around 100%.

### EXAMPLE 2

### Flat Glass Plates Provided With a Coating Layer Formed By Thermal Crosslinking

(a) Preparation of the Coating Composition

The following formulation was used, the quantities being given in parts by weight:

| | |
|---|---|
| Methacryloxypropyltrimethoxysilane | 1 |
| Glycidoxypropylmethyldiethoxysilane | 1 |
| GK6006 wax | 1.5 |
| Water | balance to |
| | 100 |

A glass coating composition was prepared by the following operating method:

The two silanes were premixed for 5 minutes and then water was added and the silanes hydrolyzed with strong stirring for 30 minutes. The wax was then added.

(b) Formation of the Coating Layer on Indented Flat Glass Plates

The procedure was then as in Example 1b, except that instead of drying followed by UV curing, a heat treatment was carried out for 25 minutes at 240° C.

(c) Fracture Test in Three-Point Bending

The same test as in Example 1c was carried out on the glass plates thus coated.

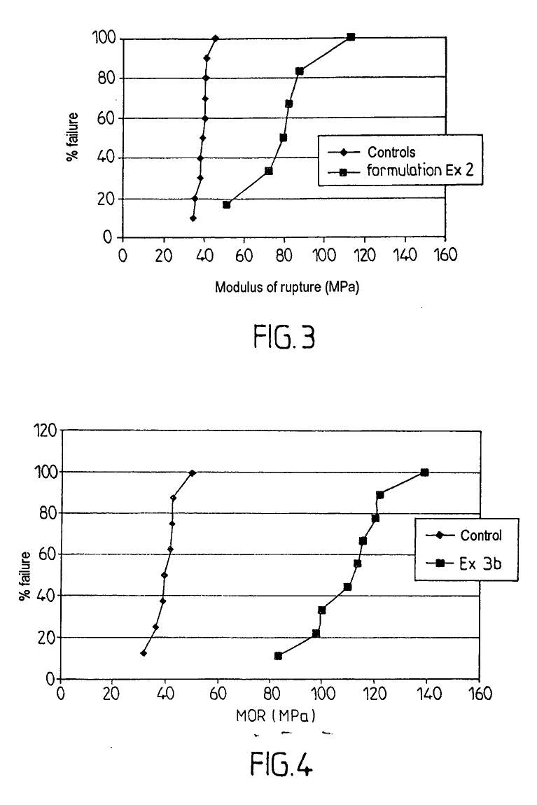

The results obtained are given in Table 2 below and also in FIG. 3.

TABLE 2

| | | Glass treated by |
|---|---|---|
| | | the formulation |
| | Uncoated controls | of this example |
| Mean fracture | 39.7 | 86.4 |
| stress (MPa) | | |
| Standard | 2.3 | 16.7 |
| deviation (MPa) | | |
| Reinforcement | | 117.8% |

### EXAMPLES 3a to 3d

### Flat Glass Plates Provided With a Coating Layer Formed By Thermal Crosslinking

(a) Preparation of the Coating Compositions

The following formulations were used, the quantities being given in parts by weight:

| | Example | | | |
|---|---|---|---|---|
| | 3a | 3b | 3c | 3d |
| 3-Aminopropyltriethoxysilane | 0.5 | 1 | 0.3 | 0.5 |
| Glycidoxypropylmethyldiethoxysilane | 1 | 2 | 1 | 1 |
| OG25 wax | 1.5 | 1.5 | 1.5 | |
| GK6006 wax | | | | 1.5 |
| Polyurethane of 25% solids content, | 1.5 | 1.5 | 1.5 | 1.5 |
| sold by Diegel under the name | | | | |
| BG 49300 | | | | |
| Deionized water, bring the balance | 100 | 100 | 100 | 100 |
| to | | | | |

The preparation comprised taking, on the one hand, a first container, containing the aminopropyltriethoxysilane and the glycidoxypropylmethyldiethoxysilane, which were mixed for 5 to 7 minutes (Example 3a) or 10 minutes (Examples 3b, 3c, 3d), and, on the other hand, a second container, containing the polyethylene wax, the polyurethane and the water, and then the contents of the two containers were mixed for 30 minutes before the application.

(b) Formation of the Coating Layer on Indented Flat Glass Plates

The procedure as in Example 2b was then carried out, except that the heat treatment (curing) was carried out at 200° C. for 20 minutes.

(c) Fracture Test in Three-Point Bending

The same test as in Example 1c was carried out on the glass plates thus coated with the composition of Example 3b.

The results are given in Table 3 below and in FIG. 4:

TABLE 3

| | | Glass treated by |
|---|---|---|
| Coating on 50 N | | the formulation |
| indentation | Controlled glass | of Example 3b |
| Mean fracture | 40.1 | 111.2 |
| stress (MPa) | | |
| Standard | 5.2 | 16.1 |
| deviation (MPa) | | |
| Reinforcement (%) | | 177.3 |

In the graph shown in FIG. 4, the curve representing the ten specimens of coated flat glass plates is shifted toward the higher modulus of rupture values compared with the curve of the ten specimens of uncoated flat glass plates.

The coating formed from the composition of Example 3b therefore gives the glass a very high mechanical strength.

(d) Three-Point Bending Test on Indented Flat Glass Plates With UV Ageing and Environmental Ageing of the Coating Formed From the Composition of Example 3b

Two ageing tests were used, namely the WOM (Weather-O-Meter) test, in which the flat glass plate specimens were exposed to UV for 540 h, and the CV (variable climate) test, in which the flat glass plate specimens underwent cycles for 15 days between −10° C. and +90° C., one cycle lasting 8 h, at 95% RH.

The results are given in FIG. 5 and in Table 4 below:

TABLE 4

| | Without | After | After |
|---|---|---|---|
| Reinforcement (%) | ageing | WOM | CV |
| Based on the composition of | 161% | 161% | 160% |
| Example 3b | | | |

The reinforcement provided by the coating based on the composition of Example 3b after the WOM and CV ageing tests is unmodified.

(e) Examination With the Naked Eye of the Appearance of the Coating Based on the Composition of Example 3b (After WOM and CV)

The glass plate having the coating based on the composition of Example 3b suffered no degradation after UV exposure for 540 hours. It was not impaired by the humidity under the conditions of the CV test described above.

### EXAMPLES 4a and 4b

### Preparation of Compositions According to the Invention With Prehydrolysis of at Least One Silane

A composition was prepared as in Example 3a, except that in Example 4a both silanes were prehydrolyzed and in Example 4b the glycidoxypropylmethyldiethoxysilane was prehydrolyzed with all the water for 15 minutes.

### EXAMPLES 5a and 5b

### Preparation of Compositions According to the Invention With Introduction of Catalysts

A composition was prepared as in Example 3a, except that, in Example 5a, 0.15 parts of triethanolamine were added to the second container.

A composition according to Example 3c was also prepared, except that, in Example 5b, 0.075 parts of triethanolamine and 0.075 parts of diethanolamine propanediol were added to the second container.

### EXAMPLE 6

### Influence of the Glycidoxypropylmethyldiethoxysilane Prehydrolysis

The FTIR spectrograms of the formulation of Example 3a with simultaneous hydrolysis at 23° C. of both silanes with and without prehydrolysis of the glycidoxypropylmethyldiethoxysilane after 23 minutes of mixing are identical.

Beyond 23 minutes, the hydrolysis of the 3-aminopropyltriethoxysilane and the glycidoxypropylmethyldiethoxysilane was complete. The prehydrolysis of the glycidoxypropylmethyldiethoxysilane did not affect the rate of hydrolysis reaction of the two silanes. However, the prehydrolysis of the glycidoxypropylmethyldiethoxysilane has an influence on the reinforcement over the course of time.

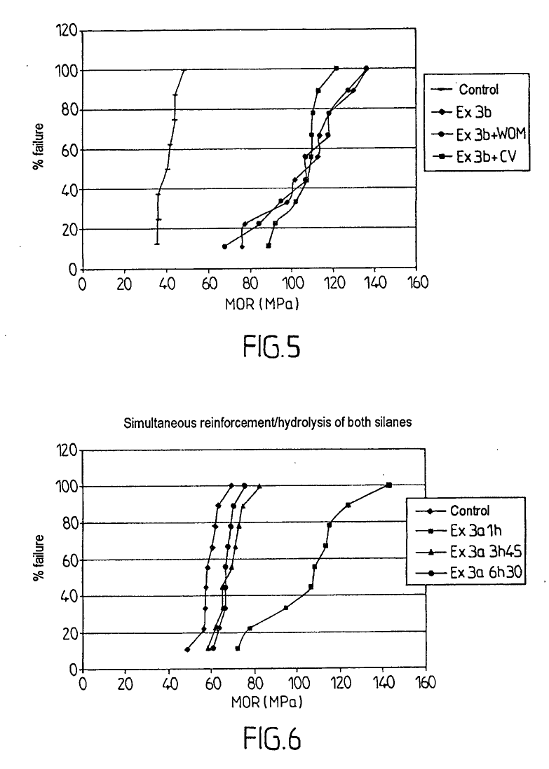

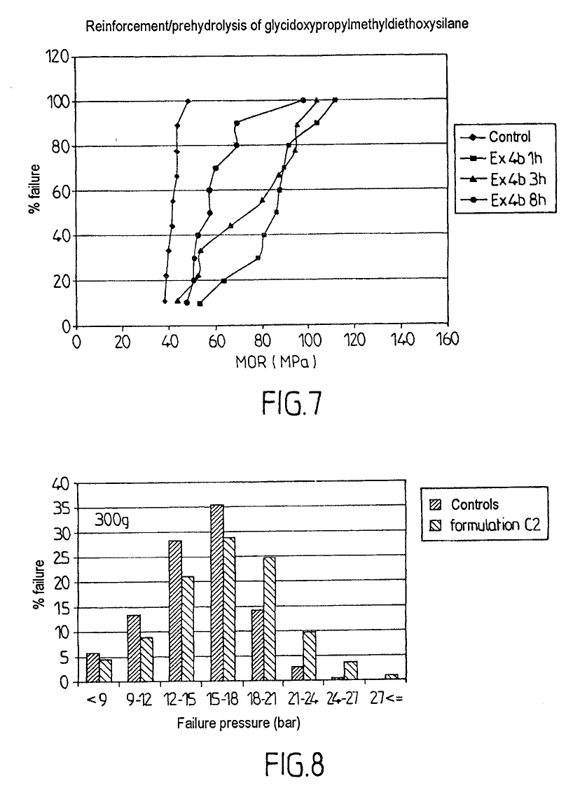

The reinforcement results on flat glass plates as a function of the maturation time (1 h, 3 h and 6 h or 8 h) for the formulations of Examples 3a and 4b are illustrated in FIGS. 6 and 7, respectively.

TABLE 5
Table summarizing the reinforcement results
with the formulations of Examples 3a and 4b in the
three-point test on 50N-indented flat glass plates

| | Percentage reinforcement for | | | | |
|---|---|---|---|---|---|
| | different maturation times | | | | |
| | | | 3 h | 6 h | |
| | 1 h | 3 h | 45 min | 30 min | 8 h |
| With the formulation | 80% | — | 17% | 14% | — |
| of Example 3a: | σ = 22.2 | | σ = 7.4 | σ = 4.3 | |
| simultaneous | | | | | |
| hydrolysis of both | | | | | |
| silanes | | | | | |
| With the formulation | 101% | 79% | — | — | 46% |
| of Example 4b: | σ = 17.4 | σ = 22 | | | σ = 15 |
| prehydrolysis of the | | | | | |
| glycidoxypropylmethyldiethoxysilane | | | | | |

σ = standard deviation.

The reinforcement on the specimens of flat glass plates indented with 50 N deteriorates over the course of time. Beyond 3 hours' life of the mixture, the reinforcement without prehydrolysis of the glycidoxypropylmethyldiethoxysilane (=simultaneous hydrolysis) and with prehydrolysis of the glycidoxypropylmethyldiethoxysilane drops. However, prehydrolysis seems to lessen this reduction in reinforcement properties: after 8 hours of ageing of the formulation, the remaining reinforcement is 46%, whereas the reinforcement with the formulation of Example 3a (with no prior prehydrolysis of the glycidoxypropylmethyldiethoxysilane) is now only 14% after 6 h 30 min of maturation of the mixture.

A recommended operating mode therefore consists in firstly hydrolyzing the glycidoxypropyl-methyldiethoxysilane for a few minutes—5 to 10 minutes—in order to achieve a lasting and stable reinforcement, in terms of level.

### EXAMPLE 7

### Behavior of the Viscosity

The viscosity of the formulation of Examples 3 and 4, with and without prehydrolysis of the glycidoxypropylmethyldiethoxysilane, is dependent on the temperature of the mixture (20° C. and 40° C.). It changes more rapidly the higher the temperature. The viscosity of the formulation is also dependent on the nature of the polyethylene wax used (OG25 or GK6006). When GK6006 is present (Example 3d), the mixture seems to be stable over time, whereas the viscosity is observed to increase when the formulation contains OG25.

### EXAMPLE 8

### Optimization of the Curing (Time and Temperature) With Tertiary Amine Catalysts

Using a triethylamine tertiary amine allows the cure time to be reduced by half (10 minutes compared with 20 minutes) and reduces the curing temperature by 50° C. (150° C. compared with 200° C.), while maintaining the level of reinforcement at about 90%.

Optimizing the formulation toward a less energy-intensive formulation favors a more economic use of the curing lehr installed in line after the cold end.

Table 6 below is a table summarizing the results obtained.

TABLE 6

| | | Formulation of example | | | |
|---|---|---|---|---|---|
| Coating on a | | 3b | 4a | | 4b |
| 50 N | | 200° C. | 200° C. | 150° C. | 150° C. |
| indentation | Controls | 20 min | 20 min | 10 min | 20 min |
| Mean (MPa) | 41.5 | 107 | 75 | 59 | 75 |
| Standard | 4.3 | 21 | 8 | 18 | 16 |
| deviation (MPa) | | | | | |
| Reinforcement (%) | | 161 | 112 | 66 | 90 |

### EXAMPLE 9

### Mechanical Reinforcement of the Edges of Glazing Panes. Tests on Flat Glass Plates for Automotive and Architectural Applications

Defects on the edges are less severe than defects created with a 50 N indentation. The cutting and shaping of the glass create smaller defects on the edges. To simulate the small edge defects, a force of 5 N was applied during the indentation. The size (indentation at 50 N or 5 N) and the nature of the defect (indentation or shaping) result in different reinforcement values for the coating of Example 3a.

Specifically, the edge reinforcement after coating the flat glass plates and after 4-point bending is 17.1%, whereas, for an indentation at 5 N and 50 N, the values obtained are 55.3 and 177.3%, respectively.

Table 7 below is a table summarizing the results obtained.

TABLE 7

| Edge reinforcement in | | Formulation of |
|---|---|---|
| 4-point bending | Control | Example 3a |
| Mean (MPa) | 83.2 | 97.4 |
| Standard deviation (MPa) | 7.1 | 4.7 |
| Reinforcement (%) | | 17.1 |
| Three-point bending: | | |
| coating on 50 N-indentation | | |
| Mean (MPa) | 40.1 | 111.2 |
| Standard deviation (MPa) | 5.2 | 16.1 |
| Reinforcement (%) | | 177.3 |
| Three-point bending: | | |
| coating on 5. N-indentation | | |
| Mean (MPa) | 81.8 | 127.0 |
| Standard deviation (MPa) | 5.9 | 21.4 |
| Reinforcement (%) | | 55.3 |

### EXAMPLES 10a and 10b

### Mechanical Reinforcement Obtained on Bottles

The following formulations were used:

Formulation of the example

| | 10a | 10b |
|---|---|---|
| Aminopropyltriethoxysilane | 0.3 | 0.3 |
| Glycidoxypropyltriethoxysilane | 1 | 1 |
| GK 6006 wax | 1.5 | 0.4 |
| Water, balance to | 100 | 100 |

The glass coating compositions were prepared using the following operating method.

The epoxysilane was hydrolyzed for 10 minutes in water and then the aminosilane was added and hydrolyzed for 20 minutes, before the GK 6006 wax was added.

The test was carried out on a bottle production line using an IS machine comprising 16 sections, 32 molds, 300 g and 410 g burgundy.

The bottles were taken upon exiting the lehr before the cold treatment, and then they are treated by cold spraying under the following conditions:

bottles top down on spinners, with two nozzles, one for treating the bottom of the bottles and the other for the body of the bottles, respectively: the specific spray nozzle for the body was 16 cm from the bottle and its spray axis was 11 cm from the bottom of this same bottle.

The nozzle for the bottom was located at 16 cm from the bottle and it sprayed the body down to 3 cm from the bottom.

The rotation speed of the spinner was 120 rpm and the spray times were chosen to achieve complete revolutions.

The atomizing air pressure was 5.5 bar.

The parameters were set so as to obtain a slip angle of about 8° with the formulation of Example 11a:
body nozzle: 4 liters/h;
bottom nozzle: 4 liters/h;
spray time: 2 seconds.

Some of the bottles taken were treated by spraying (cold bottles), dried for 15 minutes and then subjected to a heat treatment in an oven for 20 minutes at 200° C. The other bottles served as controls. Each series consisted of 320 bottles (10 bottles per mold). The entire surface of the bottles was treated, as was the bottom. The coating thickness was 150 to 300 nm.

The bottles treated with the formulation of Example 10a had a slip angle of 8° while those treated with the formulation of Example lob had a slip angle of 20°.

The strength of the bottles was evaluated in the internal pressure test (AGR apparatus). The failure histograms are given in FIGS. 8 and 9 and the mean failure pressures in Table 8 below.

TABLE 8

| | 300 g | | 410 g | | |
|---|---|---|---|---|---|
| | | Formu- | | Formu- | |
| | | lation, | | lation, | Formulation, |
| | Control | Ex. 10b | Control | Ex. 10a | Ex. 10b |
| Mean | 14.9 ± 0.4 | 16.6 ± 0.5 | 22.6 ± 0.8 | 27.3 ± 1.1 | 27.4 ± 1.10 |
| failure | | | | | |
| pressure | | | | | |
| Standard | 3.5 | 4.2 | 7.7 | 9.4 | 9.2 |
| deviation | | | | | |
| % < 12 | 19.5 | 14.5 | 6.0 | 1.6 | 2.8 |
| bar | | | | | |
| % < 15 | 49.1 | 34.4 | 19.4 | 12.3 | 11.2 |
| bar | | | | | |

### EXAMPLE 11

### Addition of an Emulsion Polymer to the Composition; Coating Formed By Thermal Crosslinking

(a) Preparation of the Coating Composition

The following formulation was used, the quantities being given in parts by weight:

| | |
|---|---|
| Glycidoxypropylmethyldiethoxysilane | 1.0 |
| 3-Aminopropyltriethoxysilane | 0.3 |
| Emulsion of a copolymer having a T_{g} of | 2.6 |
| +36° C., sold by Noveon under the brand name | |
| HYCAR ® 26391 | |
| Water | balance to |
| | 100 |

To prepare the coating composition, the epoxysilane was dissolved in water for 5 minutes. The aminosilane was then added and mixed for 15 minutes. Finally, the copolymer emulsion was added and mixed for 3 minutes.

The same formulation without the emulsion was also prepared.

(b) Deposition of the Coating on Indented Flat Glass Plates

The coating compositions thus prepared were deposited on specimens of glass plates indented at 10 N, by dipping these glass plates in said compositions at a rate of 50 cm/min, by drying the specimens in air for 10 min and then carrying out a heat treatment at 200° C. for 20 min.

(c) Fracture Test in Three-Point Bending

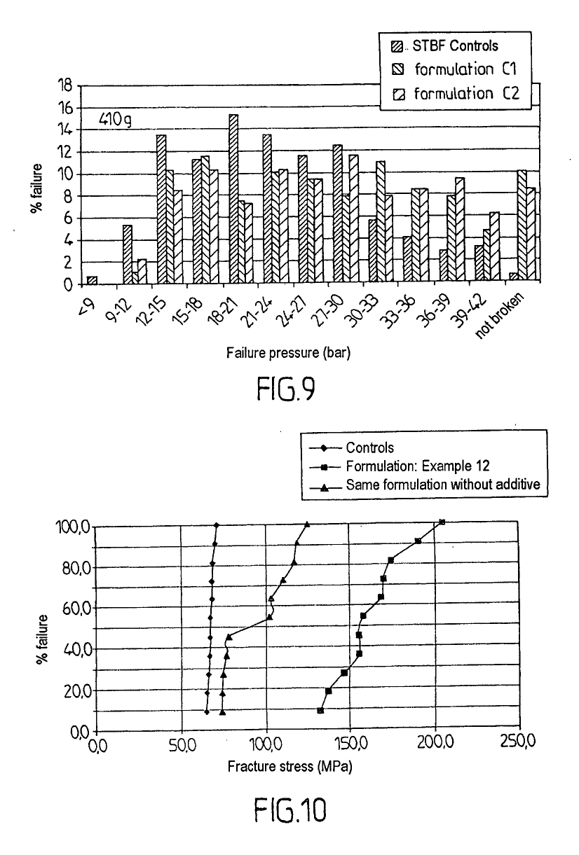

The procedure was as in Example 1a, section (c), results obtained being given in Table 9 below and also in FIG. 10.

TABLE 9

| | | | Same |
|---|---|---|---|
| | | Formulations | formulation, |
| | Uncoated | of | but without |
| | controls | Example 11 | the emulsion |
| Mean fracture | 68 | 157 | 95 |
| stress (MPa) | | | |
| Standard | 2.1 | 17.9 | 19.4 |
| deviation | | | |
| (MPa) | | | |
| Reinforcement | — | 131 | 40 |
| (%) | | | |

1. A composition for treating the surface of glass, particularly flat glass or hollow glass, or else glass in the form of fibers, said composition being able to be applied as a thin layer on said glass, and comprising, in aqueous medium, the following constituents (A) and (B)
(A) at least one compound having at least one functional group f_{(A)}; and
(B) at least one compound having at least one functional group f_{(B)} capable of reacting with the functional group or groups f_{(A)} of constituent (A) within the thin layer applied to the glass to convert said layer by polycondensation and/or polymerization into a solid layer,
at least one of the compounds satisfying the definition of (A) and (B) having at least one R—O— functional group attached to a silicon atom, R representing an alkyl residue, and
it being possible for at least some of the compounds having at least one R—O— functional group attached to a silicon atom to be in a hydrolyzed form resulting from prehydrolysis or spontaneous hydrolysis taking place during contact of the compound(s) with the aqueous medium.

2. The composition as claimed in claim 1, wherein the alkyl residue R is a linear or branched C₁-C₈ alkyl residue.

3. The composition as claimed in claim 1, wherein the functional groups f_{(A)} and f_{(B)} are chosen from —NH₂, —NH—, epoxy, vinyl, (meth)acrylate, isocyanate and alcohol functional groups.

4. The composition as claimed in claim 1, wherein the functional groups f_{(A)} and f_{(B)} of the respective constituents (A) and (B) are chosen from the following families:
amine/epoxy;
amine/(meth)acrylate;
epoxy/(meth)acrylate;
(meth)acrylate/(meth)acrylate;
vinyl/(meth)acrylate;
vinyl/vinyl;
epoxy/epoxy; and
isocyanate/alcohol.

5. The composition as claimed in claim 1, wherein constituents (A) and (B) are chosen from:
melamine, ethylenediamine and 2-(2aminoethylamino)ethanol;
derivatives of bisphenol A;
(meth)acrylate monomers or oligomers; and
compounds of formula (I):
A-Si(R¹)x(OR²)₃₋ₓ (I)
wherein:
A is a hydrocarbon radical possessing at least one group chosen from amino, alkylamino, dialkylamino, epoxy, acryloxy, methacryloxy, vinyl, aryl, cyano, isocyanato, ureido, thiocyanato, mercapto, sulfane, or halogen group linked directly to the silicon or via an aliphatic or aromatic hydrocarbon residue;
R¹ represents an alkyl group, in particular a C₁-C₃ alkyl group, or A as defined above;
R² represents a C₁-C₈ alkyl group, optionally substituted with an alkyl[polyethylene glycol] residue; and
x=0 or 1 or 2.

6. The composition as claimed in claim 1, wherein the (A)/(B) combinations are chosen from:
methacryloxypropyltrimethoxysilane/polyethylene glycol diacrylate;
methacryloxypropyltrimethoxysilane/glycidoxypropylmethyldiethoxysilane; and
3-aminopropyltriethoxysilane/glycidoxypropylmethyldiethoxysilane.

7. The composition as claimed in claim 1, further comprising:
(C1) at least one catalyst for polymerizing or polycondensing constituents (A) and (B); and/or
(C2) at least one UV or thermal, or UV cationic, radical curing initiator.

8. The composition as claimed in claim 7, wherein constituent (C1) is or comprises a tertiary amine, such as triethanolamine and diethanolamine propanediol.

9. The composition as claimed in claim 7, wherein the radical curing initiators are mixtures comprising benzophenone.

10. The composition as claimed in claim 1, further comprising:
(D) at least one agent for protecting against scratching and rubbing, chosen from waxes, partial fatty acid esters and the fatty acids, and polyurethanes and other polymers known for their protective function, such as acrylic polymers.

11. The composition as claimed in claim 1, further comprising:
(E) at least one emulsion polymer having a T_{g} of between 0 and 100° C., particularly between 10 and 80° C.

12. The composition as claimed in claim 1, further comprising:
(F) at least one surfactant.

13. The composition as claimed in claim 1, comprising, in aqueous medium, for a total of 100 parts by weight:
up to 25 parts by weight of constituent (A);
up to 25 parts by weight of constituent (B);
0 to 25 parts by weight of (C1) at least one catalyst for polymerizing or polycondensing constituents (A) and (B);
0 to 25 parts by weight of (C2) at least one UV or thermal, or UV cationic, radical curing initiator;
0 to 25 parts by weight of (D) at least one agent for protecting against scratching and rubbing, chosen from waxes, partial fatty acid esters and the fatty acids, and polvurethanes and other polymers known for their protective function, such as acrylic polymers;
0 to 25 parts by weight of (E) at least one emulsion polymer having a T_{g} of between 0 and 100° C., particularly between 10 and 80° C.; and
0 to 25 parts by weight of (F) at least one surfactant,
the aforementioned quantities being indicated as dry matter and, when an agent is introduced in the form of an aqueous solution or emulsion, the quantity of water of this solution or emulsion then forming part of the aqueous medium of the composition.

14. The composition as claimed in claim 1, wherein the functional groups f_{(A)} of constituent (A) are —NH₂ and/or —NH— functional groups and the functional groups f_{(B)} of constituent (B) are epoxy functional groups, the ratio of the number of —NH— functional groups of constituent (A) to the number of epoxy functional groups is between 0.3/1 and 3/1, limits inclusive, especially between 0.5/1 and 1.5/1, limits inclusive.

15. The composition as claimed in claim 1, having a viscosity at room temperature between 1 and 3 centipoise according to the rotary cylinder method.

16. A method of treating a glass surface in order to improve its mechanical strength by healing surface defects, the method comprising applying a thin film of the composition as defined in claim 1, to the glass parts to be treated, with a thickness that may range up to 3 microns, and said composition undergoes a polymerization or polycondensation reaction.

17. The method as claimed in claim 16, further comprising drying the applied thin film and then passing same beneath UV lamps, the treatment lasting, for example, from a few seconds to 30 seconds.

18. The method as claimed in claim 16, wherein a polymerization or polycondensation reaction is carried out thermally.

19. The method as claimed in claim 16, wherein the glass to be coated is hollow glass, the method including depositing the composition by spraying it onto the hollow glass after an annealing lehr, the temperature of the hollow glass during the spraying being from 10-150° C., and
when the composition does not contain a catalyst, then making the hollow glass pass through a curing lehr at a temperature between 100 and 220° C. for a period of time ranging from a few seconds to 10 minutes; and
when the composition does contain a catalyst, in allowing the curing to take place without passing through a curing lehr.

20. Flat glass or hollow glass treated by a composition as defined in claim 1, the composition being applied to glass parts to be treated in a thickness up to 3 microns, the compositions undergoing a polymerization or polycondensation reaction.

21. Glass fiber, especially optical fiber, treated by a composition as defined in claim 1, the composition being applied to glass parts to be treated in a thickness up to 3 microns, the compositions undergoing a polymerization or polycondensation reaction.

22. (canceled)
